(19) United States
(12) Patent Application Publication
(10) Pub. No.: US 2015/0066083 A1
(43) Pub. Date: Mar. 5, 2015

(54) PACIFIER WITH MANETIC COUNTERWEIGHT BASE

(71) Applicant: MILTON RAMOS, WACO, TX (US)

(72) Inventor: MILTON RAMOS, WACO, TX (US)

(21) Appl. No.: 14/522,796

(22) Filed: Oct. 24, 2014

Related U.S. Application Data
(60) Provisional application No. 61/953,879, filed on Mar. 16, 2014.

(51) Int. Cl. A61J 17/00

(52) U.S. Cl. CPC A61J 17/00
USPC 606/235

(57) ABSTRACT

A pacifier with magnetic counterweight base; The invention is of a pacifier with nipple and a round body and also a magnetic counterweight base which counter acts the weight of the nipple and forces the nipple to stay upright on any surface the pacifier is placed. The magnetic base allows for mounting to any metal surface or specifically designed clothing.

### CROSS-REFERENCES TO RELATED APPLICATIONS

Not Applicable

### STATEMENT REGARDING FEDERALLY SPONSORED RESEARCH OR DEVELOPMENT

Not Applicable

### MOCRIFICHE APPENDIX

Not Applicable

### BACKGROUND OF THE INVENTION

1. Field of the invention

This invention relates to the field of an infant pacifier. More specifically, the invention comprises of a pacifier with nipple, round shaped body, and a magnetic counterweight base.

2. Description of the Related Art

There are many different types of infant pacifiers for infants. One good example is a pacifier with a swivel ring for a strap attachment which in turn attaches to an infant's clothes.

The present invention seeks to make the pacifier more bacteria and germ free and also easier to store when not in use.

### BRIEF SUMMARY OF THE PRESENT INVENTION

The present invention comprises of an infant pacifier with a round body and a magnetic counterweight base opposite the nipple. The counterweight allows the pacifier to toggle along its round body, but does not allow the nipple to ever touch the surface that it is placed. The pacifier also comprises of a magnetic bottom which allows the pacifier to be mounted to any metal surface when not in use which also keeps nipple from touching any surface. The pacifier's magnetic base will also have the capability of being mounted to specially designed infants attire such as baby bibs, baby shirts and any clothing specifically designed for mating with pacifier's magnetic base.

### BRIEF DESCRIPTION OF THE SEVERAL VIEWS OF THE DRAWINGS

FIG. 1 is a perspective view, showing the present invention

FIG. 2 is a perspective view, showing the motion of which the pacifier can toggle but will never tip over onto nipple.

FIG. 3 is a perspective view, which shows the pacifier as if it were being dropped nipple leading to demonstrate how the counterweight base forces the nipple to turn in mid-air allowing the pacifiers base to land first instead of nipple.

FIG. 4 is a perspective view, which shows the pacifiers mounting possibilities. One examples shows pacifier mounted on refrigerator the other shows pacifier mounted to stroller.

FIG. 5 is a perspective view, which shows the pacifier placed on infant's attire. One example shows pacifier mounted to an infant's baby bib the other shows pacifier mounted to an infant's shirt. Both bib and shirt are specially designed infant attire.

### REFERENCE NUMERALS IN THE DRAWINGS

1. Pacifier

2. Nipple

3. Pacifier body

4. Counterweight magnetic base

5. Refrigerator

6. Stroller

7. Counter top

8. Baby bib

9. Baby t-shirt

### DETAILED DESCRIPTION OF THE INVENTION

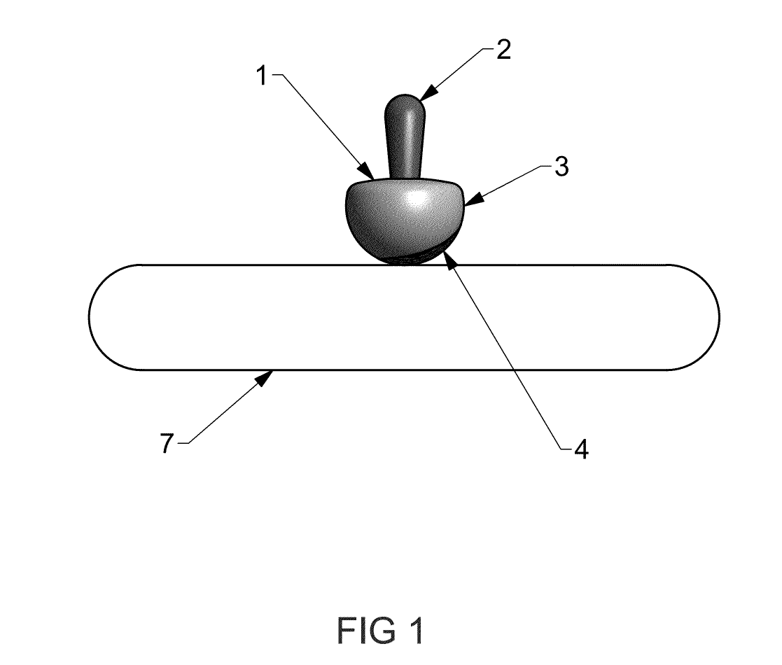

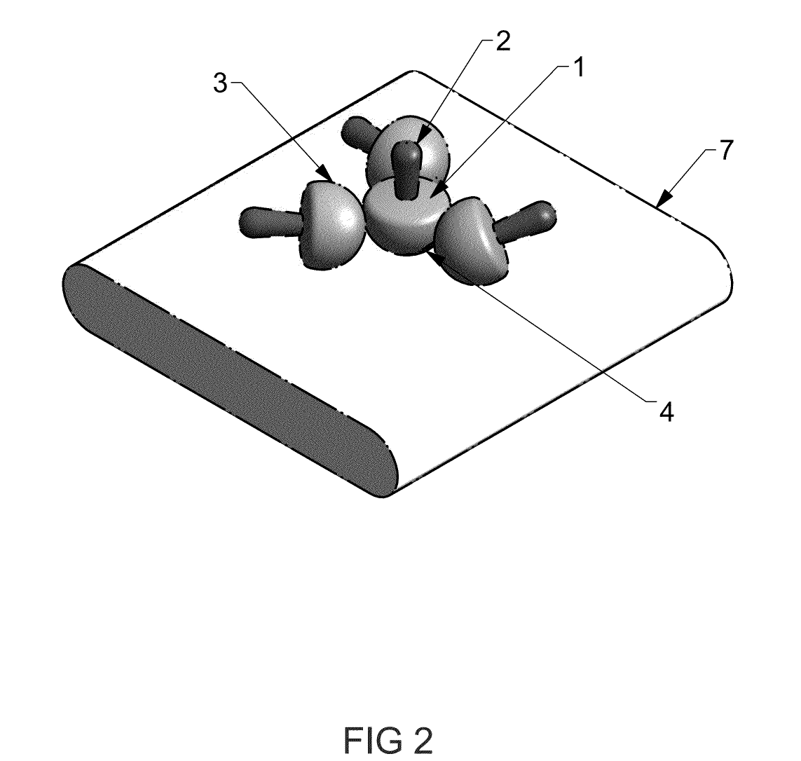

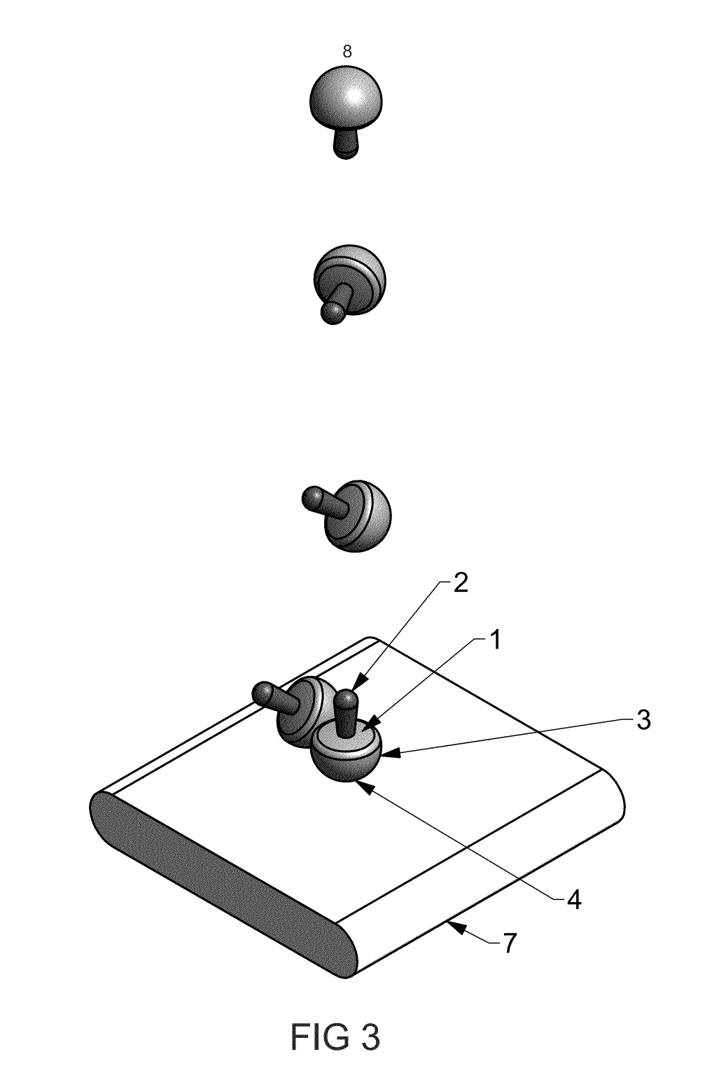

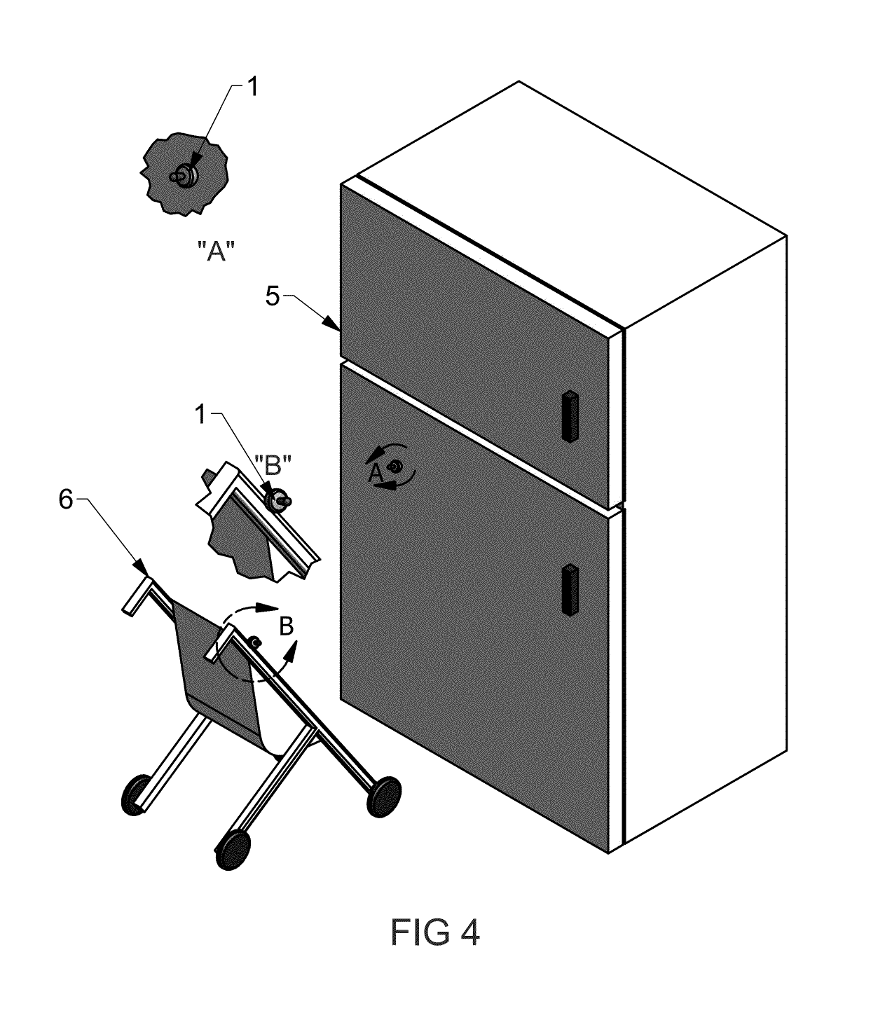

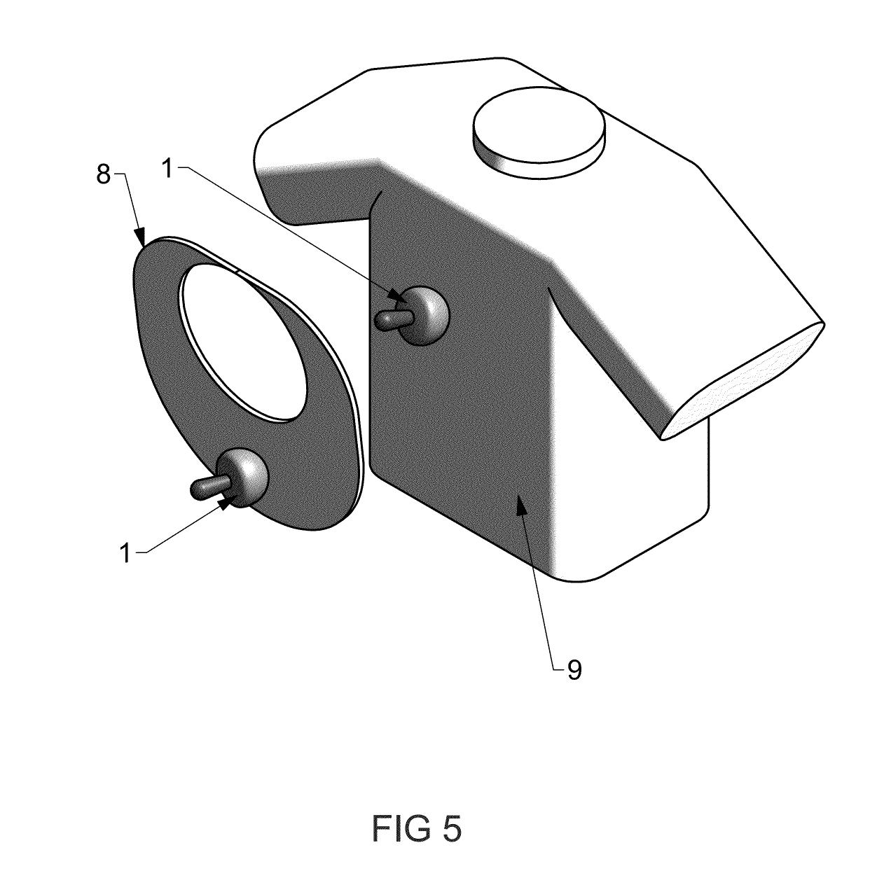

FIG. 1 shows a perspective view of the present invention in its normal position where the nipple is up away from surface. FIG. 2 shows the pacifier 1 in different toggled positions, but never allowing nipple 2 to touch counter surface 7. This is possible because of the magnetic counterweight base 4. The pacifier 1 will always sway back to its upright position. FIG. 3 shows the pacifier 1 as if it were being dropped to demonstrate the magnetic counterweight base 4 forcing the nipple 2 to turn in midair upward so that the bottom lands first on surface. FIG. 4 shows a perspective view of the pacifier 1 mounted to a refrigerator 5 and a stroller 6. This is accomplished with the pacifier's magnetic counterweight base 4. FIG. 5 illustrates how the pacifier 1 will mount to a baby bib 8 and an infant t-shirt 9. Both are custom designed infant attire specifically designed for mating with magnetic counterweight base 4.

Although the preceding description contains significant details it should not be construed as limiting the scope of the invention, but rather as providing an illustration of the preferred embodiment of the invention. As an example, the magnetic counterweight base 4 may be fixed or floating. Such a variation would not materially alter the nature of the invention. Thus, the scope of the invention should be fixed by the following clams rather than any examples provided.

What is claimed is:

1. Pacifier with magnetic counterweight base, comprising; a nipple with a round body and an integrated magnetic counterweight base.

2. Pacifier with magnetic counterweight base of claim 1, wherein the nipple will not touch the surface keeping it free of germs, dirt and bacteria.

3. Pacifier with magnetic counterweight base of claim 1, wherein the round body allows the pacifier to roll and toggle on any flat surface.

4. Pacifier with magnetic counterweight base of claim 1, wherein the magnetic counter weight base counters the weight of the nipple which always keeps the nipple in an upright position.

5. Pacifier with magnetic counterweight base of claim 1, wherein the magnetic base allows pacifier to be mounted to any metal surface.

6. Pacifier with magnetic counterweight base of claim 1, wherein the magnetic base will mate with specially designed infant attire.
